(19) United States
(12) Patent Application Publication
(10) Pub. No.: US 2022/0128229 A1
(43) Pub. Date: Apr. 28, 2022

(54) LAMP FOR REGULATING COLOR TEMPERATURE WITH TOGGLE SWITCH

(71) Applicants: XIAMEN MEIFULAI INDUSTRY AND TRADE CO., LTD, XIAMEN (CN); XIAMEN ZHANYUE ELECTRONICS CO., LTD, XIAMEN (CN)

(72) Inventor: GUANGBIN DENG, XIAMEN (CN)

(21) Appl. No.: 17/182,249

(22) Filed: Feb. 23, 2021

(30) Foreign Application Priority Data
Oct. 27, 2020 (CN) 202022424590.4

(51) Int. Cl. F21V 23/04

(52) U.S. Cl. CPC F21V 23/04; F21K 9/238

(57) ABSTRACT

Disclosed is a lamp for regulating color temperature with a toggle switch, comprising an exterior decorative housing, the inner part of the exterior decorative housing is provided with a photoelectric integrated plate and a heat sink, the heat sink is located above the photoelectric integrated plate, and the surface of the exterior decorative housing is provided with a toggle switch. By utilizing the mechanical characteristics of toggle switch, the lamp can form different logical arrangements, get different color temperatures, have low cost and good consistency. The innovative proposal of installing toggle switch on the photoelectric integrated plate makes circuits simple to install and easy to operate, and improves production efficiency.

### CROSS REFERENCE OF RELATED APPLICATIONS

This application claims all benefits accruing under 35 U.S.C. § 119 from China Patent Application No. 202022424590.4, filed on Oct. 27, 2020, in the State Intellectual Property Office of China, the disclosure of which is incorporated herein by reference in its entirety.

### TECHNICAL FIELD

The disclosure relates to the technical field of intelligent lamps, in particular to a lamp for regulating color temperature with toggle switches.

### BACKGROUND

A lamp is an apparatus that transmits light, distributes light and changes light distribution of a light source, including all parts required for fixing and protecting the light source except the light source, as well as wiring accessories necessary for connecting to the power source. Early lamps resembled pottery dishes called “beans”. There is a upper plate and a lower base which are connected by pillars in the middle, Although it has a simple shape, it has established a basic design of Chinese oil lamps. After thousands of years of development, functions of the lamp have gradually changed from initial single practicality to combination of practicality and decoration. These exquisite lamps and lanterns unearthed from tombs and works handed down from palaces, with sophisticated design and rich decoration, reflect aesthetic fashion of mainstream society at that time.

The existing lamp regulates color temperature by means of electronic regulation, such as single-chip computer and dimmer. This scheme has high cost and complex application circuits, which is not conducive to large-scale application of color temperature regulating, Therefore, the market urgently needs to develop a new type of lamp for regulating color temperature to solve the above problems.

### SUMMARY

The purpose of the disclosure is to provide a lamp regulating color temperature with a toggle switch, so as to solve the problem that the existing lamp in the prior art.

To achieve the above purpose, the disclosure provides the following technical proposal: a lamp for regulating color temperature with a toggle switch, comprising an exterior decorative housing, an inner part of the exterior decorative housing is provided with a photoelectric integrated plate and a heat sink, the heat sink is located above the photoelectric integrated plate , and a surface of the exterior decorative housing is provided with a toggle switch, the photoelectric integrated plate is electrically connected to the toggle switch.

Preferably, the exterior decorative housing is a cylindrical housing or bulb housing.

Preferably, a bottom of the cylindrical housing is provided with a wire housing cover .

Preferably, a top of the cylindrical housing is provided with a heat sink housing.

Preferably, an upper surface of the heat sink housing is inlaid with a light guide plate.

Preferably, the toggle switch is mounted on a upper surface, a lower surface or a side surface of the exterior decorative housing.

Compared with the prior art, the beneficial effect of the disclosure is:

The photoelectric integrated plate and heat sink are installed in the interior of the exterior decorative housing, the toggle switch is installed on the surface of the exterior decorative housing, the photoelectric integrated plate is electrically connected to the toggle switch. Different logical arrangement can be formed by utilizing the mechanical characteristics of toggle switch, which results in different color temperature and has low cost and good consistency. An innovative proposal is put forward to install the toggle switch on the photoelectric integrated plate, which makes circuits simple to install and easy to operate and improves production efficiency.

### BRIEF DESCRIPTION OF DRAWINGS

FIG. 1 is an exploded view of a lamp for regulating color temperature with a toggle switch in embodiment 1 of the present disclosure.

FIG. 2 is a schematic diagram of an overall structure of a lamp for regulating color temperature with a toggle switch in embodiment I of the present disclosure..

FIG. 3 is an exploded view of a lamp for regulating color temperature with a toggle switch in embodiment 2 of the present disclosure.

FIG. 4 is a schematic diagram of an overall structure of a lamp for regulating color temperature with a toggle switch in embodiment 2 of the present disclosure.

FIG. 5 is an an exploded view of a lamp for regulating color temperature with a toggle switch in embodiment 3 of the present disclosure, in which the toggle switch is at an upper surface.

FIG. 6 is a schematic diagram of an overall structure of a lamp for regulating color temperature with a toggle switch in embodiment 4 of the present disclosure, in which the toggle switch is at the lower surface.

Wherein: 1. heat sink housing; 2. light guide plate; 3. heat sink; 4. toggle switch; 5. photoelectric integrated plate; 6. exterior decorative housing; 7, wire housing cover; 61. bulb housing body.

### DETAILED DESCRIPTION

in the following, the technical scheme of the present disclosure will be described clearly and completely in conjunction with the drawings of embodiments of the disclosure. Obviously, the described embodiments are only part of, but not all of the embodiments of the disclosure.

Embodiment 1

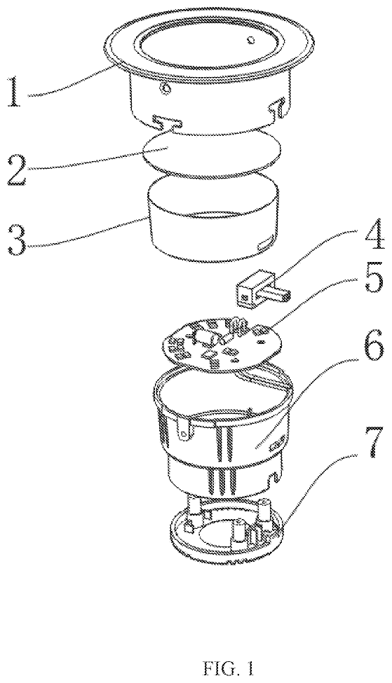

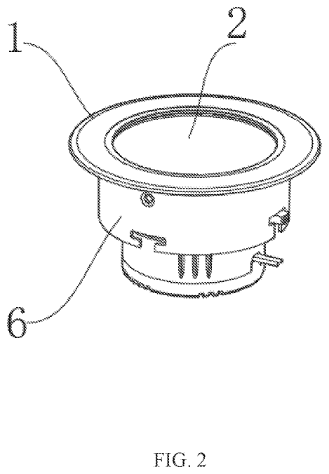

Referring to FIG. 1-2, one embodiment of the disclosure: a lamp for regulating color temperature with a toggle switch, comprising an exterior decorative housing 6 an inner part of the exterior decorative housing 6 is provided with a photoelectric integrated plate 5 and a heat sink 3, the heat sink 3 is located above the photoelectric integrated plate 5, and a side surface of the exterior decorative housing 6 is provided with a toggle switch 4, the photoelectric integrated plate 5 is electrically connected to the toggle switch 4.

Further, the exterior decorative housing 6 is a cylindrical housing.

Further, a bottom of the exterior decorative housing 6 is provided with a wire housing cover 7.

Further, a top of the exterior decorative housing 6 is provided with a sink housing 1.

Further, an upper surface of the heat sink housing 1 is inlaid with a light guide plate 2.

Further, the toggle switch 4 is a patch toggle switch.

Working Principle: when in use, the inner part of the exterior decorative housing 6 is provided with the photoelectric integrated plate 5 and the heat sink 3, the heat sink 3 is located above the first photoelectric integrated plate 5, the side surface of the exterior decorative housing 6 is provided with the toggle switch 4, and the photoelectric integrated plate and the toggle switch 4 are connected through wires,. By utilizing the mechanical characteristics of the patch toggle switches, different logical arrangements can be formed, different color temperatures can be obtained, and the cost is low and the consistency is good. Innovatively, it is proposed that the toggle switch are installed on the photoelectric integrated plate, which makes circuits simple to install and easy to operate, and improves production efficiency.

Embodiment 2

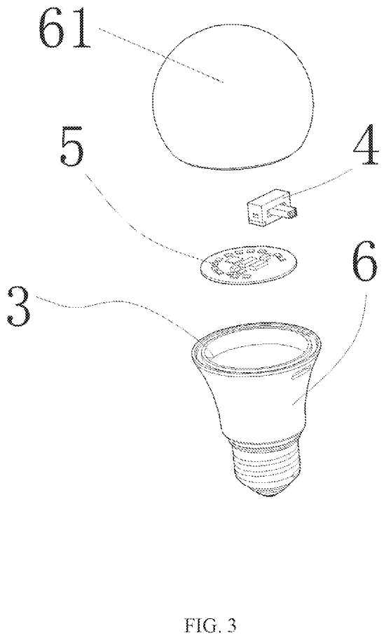

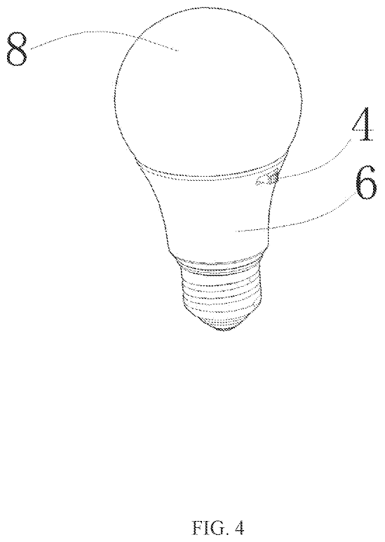

Referring to FIG. 3-4, differ from Embodiment 1 in that the exterior decorative housing 6 is a bulb housing with a bulb housing body 61.

Embodiment 3

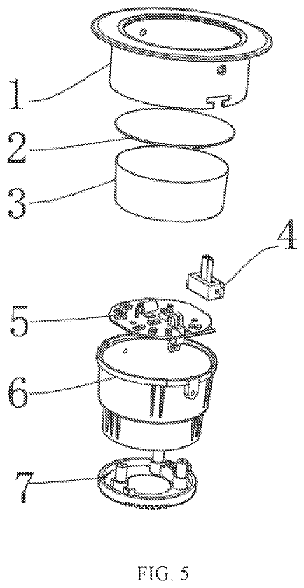

Referring to FIG. 5, differ from Embodiment 1 in that the toggle switch 4 is mounted on the upper surface of the exterior decorative housing 6.

Embodiment 4

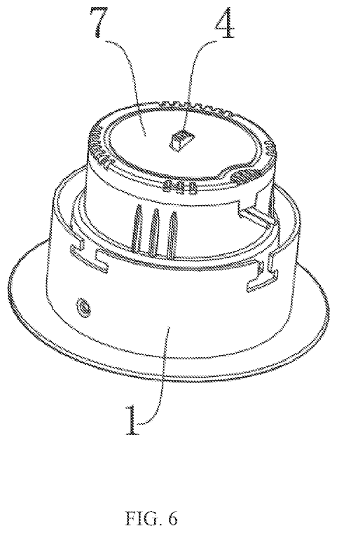

Referring to FIG. 6 , differ from Embodiment 1 in that the toggle switch 4 is mounted on the lower surface of the exterior decorative housing 6.

For those skilled in the art, it is obvious that the disclosure is not limited to the details of the above exemplary embodiments, and that the disclosure can be implemented in other specific forms without departing from the spirit or basic features of the disclosure. Therefore, in any case, the embodiments should be considered exemplary and non-restrictive, and the scope of the disclosure is limited by the appended claims rather than the above description, so that all changes within the meaning and scope of the equivalent elements of the claims are included in the disclosure. Any appendix in the claims shall not be deemed to limit the claims involved.

1. A lamp for regulating color temperature with a toggle switch, comprising an exterior decorative housing, wherein an inner part of the exterior decorative housing is provided with a photoelectric integrated plate and a heat sink, the heat sink is located above the photoelectric integrated plate, and a surface of the exterior decorative housing is provided with a patch toggle switch, the photoelectric integrated plate is directly and electrically connected to the toggle switch to regulate the color temperature of the lamp by mechanically operating the patch toggle switch.

2. The lamp for regulating color temperature with a toggle switch according to claim 1, wherein the exterior decorative housing is a cylindrical housing or bulb housing.

3. The lamp for regulating color temperature with a toggle switch according to claim 2, wherein a bottom of the cylindrical housing is provided with a wire housing cover.

4. The lamp for regulating color temperature with a toggle switch according to claim 2, wherein a top of the cylindrical housing is provided with a heat sink housing.

5. The lamp for regulating color temperature with a toggle switch according to claim 4, wherein an upper surface of the heat sink housing is inlaid with a light guide plate.

6. The lamp for regulating color temperature with a toggle switch according to claim 1 wherein the patch toggle switch is mounted on an upper surface, a lower surface or a side surface of the exterior decorative housing.
